(19) United States
(12) Patent Application Publication
(10) Pub. No.: US 2008/0224370 A1
(43) Pub. Date: Sep. 18, 2008

(54) LATCHING RACK DAMPER ASSEMBLY

(76) Inventor: CALVIN DERR, Chicago, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/959,632

(22) Filed: Dec. 19, 2007

Related U.S. Application Data
(60) Provisional application No. 60/918,009, filed on Mar. 14, 2007.

(51) Int. Cl. F16F 7/00

(52) U.S. Cl. 267/195

(57) ABSTRACT

A latching rack damper assembly configured to dampen movement between two structures includes a rack and a damper housing. The rack includes a toothed track and an integrally formed first latching member. The damper housing is movably secured to the rack and includes a second latching member configured to securely latch to the first latching member.

### RELATED APPLICATIONS

This application relates to and claims priority benefits from U.S. Provisional Patent Application No. 60/918,009 entitled “Latching Rack Damper Assembly,” filed Mar. 14, 2007, which is hereby incorporated by reference in its entirety.

### FIELD OF THE INVENTION

Embodiments of the present invention generally relate to a system and method for dampening the movement of attached components, and more particularly, to a latching rack damper assembly.

### BACKGROUND OF THE INVENTION

Various vehicle assemblies include assemblies, such as rotary dampers, configured to dampen pivotal movements of structures in the interior of the vehicle. For example, a flap for closing a glove compartment, ashtray, handle or the like may be connected to such an assembly.

Conventional rotary dampers include a rotor that is rotatably mounted in a housing. A braking fluid, such as a silicone oil between the rotor and the housing, may be used to dampen movement when the rotor is rotated in the housing. A pinion that engages a tooth segment is mounted on the rotor shaft.

U.S. Pat. No. 5,862,896 discloses a device for dampening the movement of a pivotally supported structural part, for example, a flap or closure within an automobile. The device includes a pivot arm attached to a structural part, and a rack operatively connected to the pivot arm.

U.S. Pat. No. 5,518,223 discloses an air damper assembly for controlling the dampening rate of an openable object. The air damper assembly includes a piston head having a molded channel therein and a lip seal member disposed around the connecting member of the piston head to form a continuous seal therebetween.

### SUMMARY OF THE INVENTION

Embodiments of the present invention provide a latching rack damper assembly that is efficiently manufactured and assembled.

Certain embodiments of the present invention provide a latching rack damper assembly configured to dampen movement between two structures. The assembly includes a rack and a damper housing.

The rack may include a toothed track on a first side and an integrally formed first latching member on a second side, wherein the first side is opposite the second side. Additionally, the latching member may be proximate an end of the rack.

The damper housing is movably secured to the rack. The damper housing may include first and second rack engagement cuffs that secure the damper housing to the rack. A damper may be connected to the first and second rack engagement cuffs. The damper may also be operatively connected to a pinion that engages the toothed track. The damper housing also includes a second latching member configured to securely latch to the first latching member. The second latching member may be positioned on or within at least one of the first and/or second rack engagement cuffs.

The first latching member may include a latch track and the second latching member may include a latching follower slidably secured within a slot formed in one of the first or second rack engagement cuffs. Alternatively, the first latching member may include a protuberance and the second latching member may include a reciprocal opening, wherein the reciprocal opening snapably engages the protuberance in a latched position.

The damper housing may also include a keyed panel securing member configured to securely retain a panel. For example, the keyed panel securing member may pass into a reciprocal channel formed in a panel, and then rotated relative to the panel to ensure that the keyed panel securing member does not pass through the reciprocal channel.

Certain embodiments of the present invention provide a system for dampening movement between two structures. The system includes a first panel, a second panel configured to move relative to the first panel, and a latching rack damper assembly secured to the first panel and the second panel. The latching rack damper assembly includes a rack having a toothed track and an integrally formed first latching member, and a damper housing movably secured to the rack. The damper housing includes a second latching member configured to securely latch to the first latching member.

### BRIEF DESCRIPTION OF SEVERAL VIEWS OF THE DRAWINGS

FIG. 1 illustrates a top view of a latching damper rack assembly according to an embodiment of the present invention.

FIG. 2 illustrates a bottom view of a latching damper rack assembly according to an embodiment of the present invention.

FIG. 3 illustrates an isometric view of a latching damper rack assembly secured to a portion of a panel according to an embodiment of the present invention.

FIG. 4 illustrates an isometric view of a damper housing engaging a rack according to an embodiment of the present invention.

FIG. 5 illustrates an isometric view of a latching damper rack assembly being mounted to a stationary component according to an embodiment of the present invention.

FIG. 6 illustrates an isometric view of a latching damper rack assembly being secured to a stationary component according to an embodiment of the present invention.

FIG. 7 illustrates a front view of a latching damper rack assembly secured to a stationary component according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

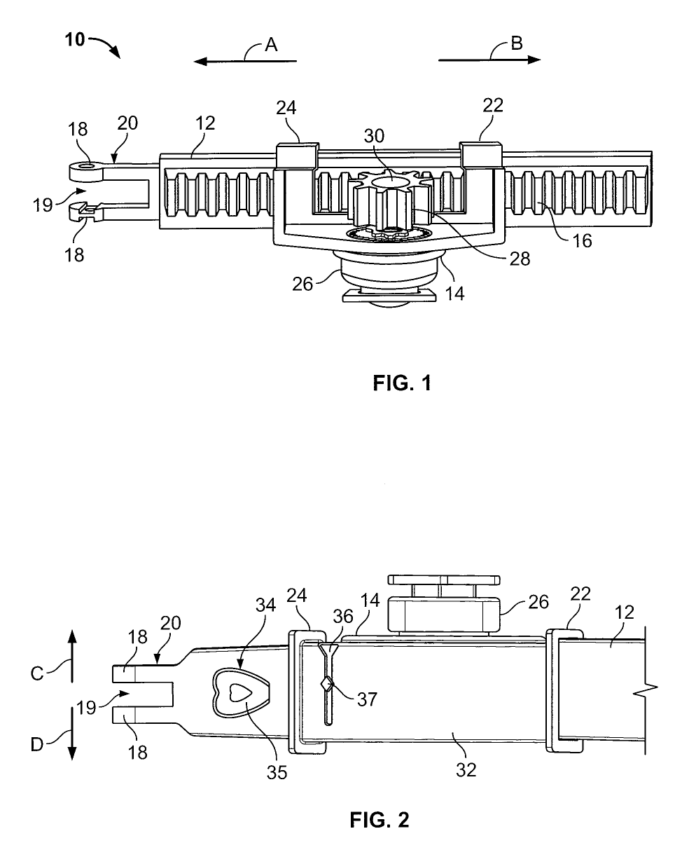

FIG. 1 illustrates a top view of a latching damper rack assembly 10 according to an embodiment of the present invention. The latching damper rack assembly 10 includes a rack 12 and a damper housing 14. The damper housing 14 may be configured to move over the rack 12 in order to translate rotational movement into linear motion.

The rack 12 is a generally linear beam that includes a toothed track 16 and two aligned securing beams 18 separated by a gap 19. The securing beams 18 are positioned at an end 20 of the rack 12.

The damper housing 14 includes a rack engagement cuff 22 and a rack engagement cuff 24, both of which are connected to the damper 26. The cuffs 22 and 24 ensure that the damper housing 14 remains slidably or otherwise movably secured on the rack 12. The damper 26 includes a dampening device including a gear enclosed within the damper housing 14 operatively connected to a pinion 28 having a plurality of teeth 30 that operatively engage the toothed track 16. The damper housing 14 is configured to dampen movement in a similar way as that described in U.S. Pat. No. 5,862,896 or U.S. Pat. No. 5,518,223, both of which are hereby incorporated by reference in their entireties.

In operation, the damper housing 14 moves over the rack 12 in directions denoted by arrows A and B. The damper housing 14 dampens vibrations or the like caused by movement of components to which the assembly 10 secures. The damper housing 14 may be configured to provide one-way or two-way dampening. That is, the damper housing 14 may dampen movement as it moves in the directions of arrow A and/or arrow B.

FIG. 2 illustrates a bottom view of the latching damper rack assembly 10. The rack engagement cuffs 22 and 24 are connected to one another through a planar base 32 that connects to the damper 26, such as through side walls. In general, a rack channel is formed through the cuffs 22 and 24 and the planar base 32 and is configured to receive the rack 12.

A latching protuberance 34 having a latch track 35 formed therein is integrally formed with the rack 12. For example, the latching protuberance may be formed from a single mold in which the entire rack 12, including the latching protuberance 34, is molded to form a single, unitary piece. The latching protuberance 34 is not, however a separate and distinct component that is separately formed from, and separately affixed to, the rack 12. As such, the process of manufacturing the rack 12 and latching protuberance 34 is made simpler, considering that a separate mold is not needed to form the latching protuberance, and there is no separate assembly step of securing a separate and distinct latch to the rack 12.

The latching protuberance 34 extends downwardly from the rack 12 and is configured to latchably secure the damper housing 14 through a slot 36 formed in the rack engagement cuff 24. In particular, a latching follower 37, such as a small block, positioned within the slot 36 is configured to move through the latch track 35 between latched and unlatched positions. As such, the damper housing 14 is effectively locked in place with respect to the rack 12 through the latching follower 37 moving into a secured position within the latch track 35. Optionally, the rack 12 may include a slot with a latching follower, while the damper housing 14 includes an upwardly extending protuberance configured to securely mate into the slot.

The latch track 35 is integrally formed within the latching protuberance 34. That is, the latch track 35, along with the rest of the latching protuberance 34, is integrally molded and formed with the rack 12. Additionally, as noted above, the latching follower 37 is movably secured within the slot 36. The latching follower 37 may move through the slot 36 in the directions of arrows C and D in order to latchably secure the follower 37 (and the damper housing 14) to the latching protuberance 34 when the slot 36 moves over the latching protuberance 34, as described in U.S. Pat. No. 5,518,223. That is, the sliding latching follower 37 enters the latch track 35 and moves into a securing position within the latch track 35, thereby securely latching the damper housing 14 to the latching protuberance 34.

A spring may be used to provide a “push-push” actuation. That is, a spring may operatively connect to the damper housing 14 and the latching follower 37 and may help the latching follower 37 move along the latch track 35, giving it a push-push motion.

The latching follower 37 may be molded as a separate component from the damper housing 14. The latching follower 37 may be inserted into the slot 36 of the damper housing 14 during the assembly process. Optionally, the latching follower 37 may be molded directly onto the damper housing 14 through a thin web of plastic, such as shown and described in United States Patent Application Publication 2005/0255737, which is hereby incorporated by reference in its entirety. The web of plastic that may connect the latching follower 37 to the damper housing 14 is broken during the assembly process, allowing the latching follower to slide freely within the slot 36.

Moreover, the latch track 35 formed in the protuberance 34 may be similar to that shown in United States Patent Application Publication 2005/0255737. The latching follower 37 slides back and forth within the slot 36 while following the path of the latch track 35 of the rack 12.

In certain embodiments of the present invention, the latching follower 37 is located in the latched position when one panel or component is closed with respect to another. In order to open an application, such as a glove box, a member, such as a button, is inwardly pushed, i.e., a push-push feature, and released to allow the device to continue to open. However, embodiments of the present invention may be used in a sliding armrest application in which there are no open or closed positions, just forward and back positions.

Alternatively, the latching protuberance 34 may snapably engage a reciprocal opening formed in the damper housing 14 in order to secure the damper housing 14 to the rack 12. For example, as shown in FIG. 2, the latching protuberance 34 may have a diamond shape (or various other shapes) that secures to the damper housing 14 when the rack engagement cuff 24 slides over the latching protuberance 34 and a reciprocal opening snapably engages over the protuberance 34. In this embodiment, a separate latching follower need not be used, as the protuberance and reciprocal opening formed in the damper housing 14 snapably engage one another. The protuberance 34 and/or the rack engagement cuff 24 may be configured to flex when engaged by a plunger or button connected to a panel. Thus, in order to disengage the damper housing 14 from a locked position, the plunger or button is actuated into the protuberance 34 and/or the rack engagement cuff 24 in order to move the protuberance 34 out of a securely mated position with respect to the reciprocal opening.

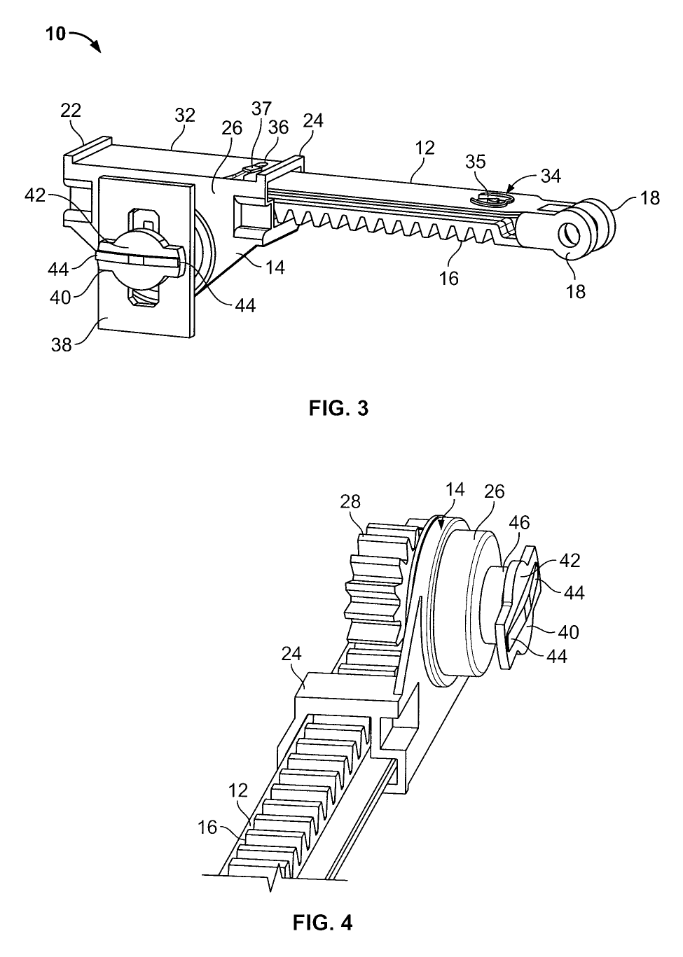

FIG. 3 illustrates an isometric view of the latching damper rack assembly 10 secured to a portion of a panel 38 according to an embodiment of the present invention. The damper housing 14 includes a panel securing member 40 that extends from a lateral surface of the damper housing 14. The panel securing member 40 includes a cylindrical main body 42 and two tabs 44 extending from sides of the main body 42. As shown in FIG. 3, the tabs 44 are 180° apart from one another, but may be located at other positions. The main body 42 and the tabs 44 provide a keying feature that cooperates with a reciprocal channel formed in the panel 38. That is, the panel securing member 40 is positioned into the reciprocal channel formed in the panel 38, and then rotated such that the tabs 44 abut wall portions of the panel 38, thereby securing the damper housing to the panel 38. As such, the panel 38, which may be a door that covers a glove compartment, is secured to the latching damper rack assembly 10.

FIG. 4 illustrates an isometric view of the damper housing 14 engaging the rack 12. As shown in FIG. 4, the panel securing member 40 secures to the damper housing 14 through a recessed extension beam 46. In the fully secured position, wall portions of the panel 38 (shown in FIG. 3) are positioned around the recessed extension beam 46 and are trapped between the main portion of the damper housing 14 and the panel securing member 40.

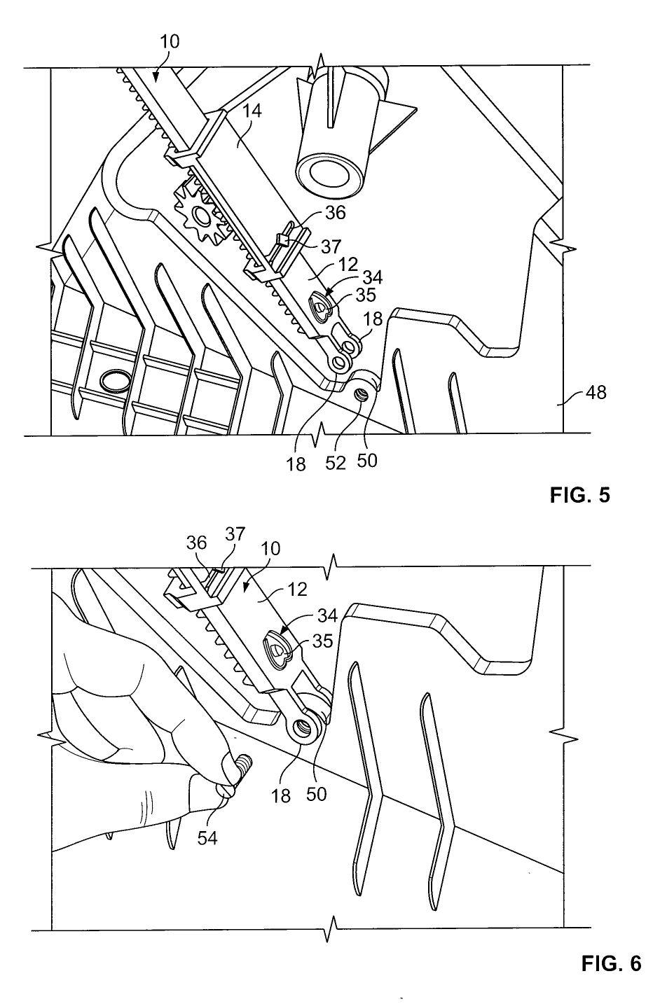

FIG. 5 illustrates an isometric view of the latching damper rack assembly 10 being mounted to a stationary component 48, such as a glove box, according to an embodiment of the present invention. As shown in FIG. 5, the rack 12 is moved toward a flap or panel 50 of the component 48 such that an edge of the panel 50 is positioned between the securing beams 18. The panel 50 includes a fastener through hole 52 that is aligned with fastener through holes formed in the securing beams 18.

FIG. 6 illustrates an isometric view of the latching damper rack assembly 10 being secured to the stationary component 48 according to an embodiment of the present invention. Once the panel 50 is positioned between the securing beams 18 and the fastener through holes are aligned, a fastener 54, such as a clip, is positioned through the fastener through holes, thereby securing the latching damper rack assembly 10 to the component 48. Thus, the latching damper rack assembly 10 may be secured to the component 48, such as a glove compartment, and the panel 38 (shown in FIG. 3), such as a pivotable door.

The latching damper rack assembly 10 dampens vibrations and the like caused by movement between the component 48 and the panel 38. The damper housing 14 dampens vibrations and the like that may result when the component 48 is moved in relation to the panel 38. The latching protuberance 34 and the slot 36 (shown, e.g., in FIGS. 2 and 3) allow the latching damper rack assembly 10 to lock into place. As such, the panel 38 may be locked into place with respect to the component 48, such as a glove compartment door being latched into a closed position with respect to the glove compartment. In order to unlock the panel 38 from the component 48, a plunger or button (not shown) located on the panel 38 or the component 48 that is aligned with the cooperating latching protuberance 34 and the slot 36 may be engaged, as discussed above, to remove the latching follower 37 (shown in FIG. 2) from the latch track 35 (shown in FIG. 2) and/or the protuberance 34 from a reciprocal opening formed in the damper housing 14.

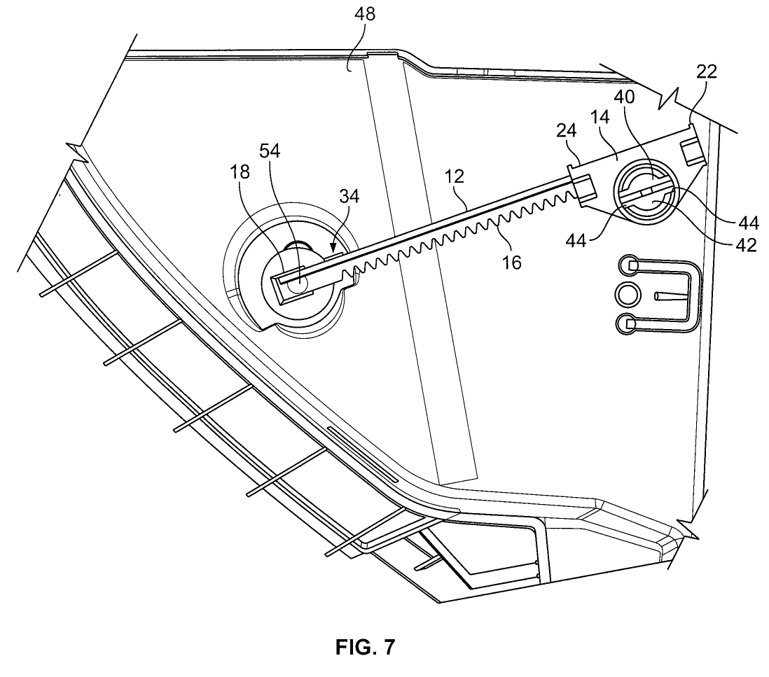

FIG. 7 illustrates a front view of the latching damper rack assembly 10 secured to the stationary component 48. For the sake of clarity, the panel 38 is not shown in FIG. 7. Once the rack 12 is secured to the component 48 and the panel 38, the latching damper rack assembly 10 may be rotated with respect to the component 48 and panel 38 about the pivot axis provided by the longitudinal axis of the fastener 54. As discussed above, the damper housing 14 dampens vibrations and the like caused by movement between the components 48 and the panel 38. Optionally, the latching damper rack assembly 10 may be secured to components that are linearly aligned and do not rotate with respect to one another. Thus, the latching damper rack assembly 10 need not necessarily pivot with respect to secured panels and components.

As discussed above, the rack 12 may be mounted to a stationary housing or shroud of a receptacle, while the damper housing 14 may be mounted to a moving lid that is pivotally secured to the housing or shroud. Alternatively, the rack 12 may be mounted to the lid, while the damper is mounted to the damper housing 14 or shroud. A separate and distinct latching member is not needed, due to the fact that the assembly 10 includes an integral latching member, such as the protuberance 34 integrally formed with the rack 12. Thus, the assembly 10 has an added feature of latching an application closed, open, or in any other desired position.

Embodiments of the present invention provide an integral latching interface, such as the protuberance 34 and the latching follower 37 within the slot 36. Thus, embodiments of the present invention do not require a separate latching mechanism formed on attached components, such as portions of a glove box, or a separate and distinct latching assembly that is separately formed and mounted to the damper housing. As such, embodiments of the present invention provide a simple assembly 10 that is efficiently manufactured and secured to components and/or panels, such as those of a glove box assembly.

Embodiments of the present invention provide an assembly that dampens the motion of an application while eliminating the need to purchase, design in, incorporate, and/or install a separate and distinct latching component. Embodiments of the present invention may be used with various applications, including automotive bins and armrests, household bins, moving trays, trash can lids, and any storage unit with a moving lid.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A latching rack damper assembly configured to dampen movement between two structures, the latching rack damper assembly comprising:
a rack comprising a toothed track and an integrally formed first latching member; and
a damper housing movably secured to said rack, said damper housing comprising a second latching member configured to securely latch to said first latching member.

2. The latching rack damper assembly of claim 1, wherein said first latching member comprises a latch track and said second latching member is a latching follower slidably secured to said damper housing.

3. The latching rack damper assembly of claim 1, wherein said first latching member comprises a protuberance and said second latching member comprises a reciprocal opening, wherein said reciprocal opening snapably engages said protuberance in a latched position.

4. The latching rack damper assembly of claim 1, wherein said damper housing comprises a damper operatively connected to a pinion, and wherein said pinion engages said toothed track.

5. The latching rack damper assembly of claim 1, wherein said first latching member outwardly extends from said rack on a side that is opposite said toothed track.

6. The latching rack damper assembly of claim 5, wherein said first latching member is proximate an end of said rack.

7. The latching rack damper assembly of claim 1, wherein said damper housing comprises first and second rack engagement cuffs that secure said damper housing to said rack, said second latching member being positioned on or within at least one of said first and/or second rack engagement cuffs.

8. The latching rack damper assembly of claim 1, wherein said damper housing comprises a keyed panel securing member configured to securely retain a panel.

9. A system for dampening movement between two structures, the system comprising:
a first panel;
a second panel configured to move relative to said first panel; and
a latching rack damper assembly secured to said first panel and said second panel, said latching rack damper assembly comprising: (i) a rack comprising a toothed track and an integrally formed first latching member; and (ii) a damper housing movably secured to said rack, said damper housing comprising a second latching member configured to securely latch to said first latching member.

10. The system of claim 9, wherein said first panel is one of a glove compartment or a door, and said second panel is the other of said glove compartment and said door.

11. The system of claim 9, wherein said first latching member comprises a latch track and said second latching member is a latching follower slidably secured within a slot of said damper housing.

12. The system of claim 9, wherein said first latching member comprises a protuberance and said second latching member comprises a reciprocal opening, wherein said reciprocal opening snapably engages said protuberance in a latched position.

13. The system of claim 9, wherein said damper housing comprises a damper operatively connected to a pinion, and wherein said pinion engages said toothed track.

14. The system of claim 9, wherein said first latching member outwardly extends from said rack on a side that is opposite said toothed track.

15. The system of claim 14, wherein said first latching member is proximate an end of said rack.

16. The system of claim 9, wherein said damper housing comprises first and second rack engagement cuffs that secure said damper housing to said rack, said second latching member being positioned on or within at least one of said first and/or second rack engagement cuffs.

17. The system of claim 9, wherein said damper housing comprises a keyed panel securing member configured to securely retain a panel.

18. A latching rack damper assembly configured to dampen movement between two structures, the latching rack damper assembly comprising:
a rack comprising a toothed track on a first side and an integrally formed first latching member on a second side, wherein said first side is opposite said second side, said latching member being proximate an end of said rack; and
a damper housing movably secured to said rack, said damper housing comprising: (i) first and second rack engagement cuffs that secure said damper housing to said rack; (ii) a damper connected to said first and second rack engagement cuffs; said damper being operatively connected to a pinion that engages said toothed track; and a (iii) second latching member configured to securely latch to said first latching member, said second latching member being positioned on or within at least one of said first and/or second rack engagement cuffs.

19. The latching rack damper assembly of claim 18, wherein said first latching member comprises a latch track and said second latching member is a latching follower slidably secured within a slot formed in one of said first or second rack engagement cuffs.

20. The latching rack damper assembly of claim 18, wherein said first latching member comprises a protuberance and said second latching member comprises a reciprocal opening, wherein said reciprocal opening snapably engages said protuberance in a latched position.

21. The latching rack damper assembly of claim 18, wherein said damper housing comprises a keyed panel securing member configured to securely retain a panel.
